(19) United States
(12) Patent Application Publication
(10) Pub. No.: US 2008/0176049 A1
(43) Pub. Date: Jul. 24, 2008

(54) PHOTO-CURABLE COMPOSITION HAVING INHERENTLY EXCELLENT RELEASING PROPERtY AND PATTERN TRANSFER PROPERTY, METHOD FOR TRANSFERRING PATTERN USING THE COMPOSITION AND LIGHT RECORDING MEDIUM HAVING POLYMER PATTERN LAYER PRODUCED USING THE COMPOSITION

(75) Inventors: Myong-do Ro, Yongin-si (KR); Hyun-Ki Kim, Hwaseong-si (KR); Soon-young Hong, Hwaseong-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/017,540

(22) Filed: Jan. 22, 2008

(30) Foreign Application Priority Data
Jan. 24, 2007 (KR) 2007-7654
Feb. 13, 2007 (KR) 2007-14977
Aug. 24, 2007 (KR) 2007-85569

(51) Int. Cl. C08F 2/48; B29C 35/04; B41M 5/00

(52) U.S. Cl. 428/195.1; 522/96; 264/401

(57) ABSTRACT

A photo-curable composition includes 100 parts by weight of a urethane-polydimethylsiloxane copolymerization prepolymer formed by a reaction of a polyol having two or more hydroxyl groups in a molecule thereof, a reactive polydimethylsiloxane having at least one reactive group selected from the group consisting of an amino group, an epoxy group, a carboxy group, a hydroxy group, a halogen atom, a thiol group, and (meth)acrylate, in the side chain or terminal group thereof, and an aliphatic or aromatic polyisocyanate compound; 10-80 parts by weight of (meth)acrylate-based monomer having a functionality of 4 or less, based on 100 parts by weight of the urethane-polydimethylsiloxane copolymerization prepolymer; and 0.1-10 parts by weight of a photoinitiator, based on 100 parts by weight of the urethane-polydimethylsiloxane copolymerization prepolymer. The photo-curable composition has an inherently excellent releasing property and a pattern transfer property. Accordingly, the use of the photo-curable composition can enhance performance efficiency of repeatedly transferring nano- or micro-scale patterns, such as in the fabrication of an optical recording medium.

### CROSS-REFERENCE TO RELATED APPLICATIONS

This application claims all benefits accruing under 35 U.S.C. §119 from Korean Patent Application No. 2007-7654, filed on Jan. 24, 2007, Korean Patent Application No. 2007-14977, filed on Feb. 13, 2007, and Korean Patent Application No. 2007-85569, filed on Aug. 24, 2007, in the Korean Intellectual Property Office, the disclosures of which are incorporated herein by reference.

### BACKGROUND OF THE INVENTION

1. Field of the Invention

Aspects of the present invention relate to a photo-curable composition, a method for transferring a pattern using the same, and an optical recording medium having a polymer pattern layer produced using the same. More particularly, aspects of the present invention relate to a photo-curable composition having an inherently excellent releasing property and pattern transfer property, a method for transferring a pattern using the same, and an optical recording medium having a polymer pattern layer produced using the same.

2. Description of the Related Art

In the manufacture of an optical or magnetic recording medium such as a compact disc, a digital versatile disc (DVD) or a magnetic disc, a semiconductor device, a display device, an ultramicro device, and so on, micropatterns are typically formed on a substrate. Traditionally, micropatterns are formed by photolithography including a light irradiation process using a photomask, a developing process, and an etching process. In photolithography, a photoresist made of a photosensitive polymer material is coated onto a substrate and then exposed to light having a predetermined wavelength through a photomask having a predetermined pattern to form a latent photoresist pattern, which is then developed to form a photoresist pattern on the substrate. The substrate is etched using the photoresist pattern as an etch mask to transfer the photomask pattern to the substrate. The pattern linewidth in photolithography is determined based on the wavelength of light used in the exposure process. However, existing photolithography techniques are not suitable for forming ultramicropatterns having a line width of below 100 nm on a substrate. In addition, existing photolithography involves various steps, including a photoresist coating step, an exposing step, a developing step, an etching step, a cleaning step, etc., that require a complicated patterning process, an extended processing time and a variety of expensive devices and equipment. Accordingly, existing photolithography methods are disadvantageous from the standpoints of cost and productivity.

To overcome the limitations of conventional photolithography, various non-traditional lithographic methods have been developed, and nano-imprint lithography is one of these techniques that have recently been developed.

The nano-imprint lithography technique is a refinement of existing pressing fabrication techniques to generate features as small as possible at a nano scale. According to this technique, a mold having a predetermined 3D topological pattern at a nano scale and made of a hard material such as silicon (Si), silicon dioxide, or quartz, is pressed on a substrate to transfer the 3D pattern to the substrate. In more detail, the mold is positioned to face the substrate, which is coated with a thermoplastic polymer material, followed by pressing to transfer the 3D pattern of the mold onto the thermoplastic polymer material of the substrate. Next, the substrate beneath the transferred thermoplastic polymer material pattern is etched using the transferred thermoplastic polymer material pattern as an etch mask or another material is deposited on the pattern to transfer the pattern of the mold to the substrate. The mold may be used repeatedly to form the pattern on substrates.

The nano-imprint lithography technique is largely classified into a thermoplastic nano-imprint method, a photo nano-imprint method, and a micro-contact printing (μCP) method, and so on. In the thermoplastic nano-imprint method, a substrate is coated with a thermoplastic polymer resin and then heated to above a glass transition temperature of the polymer resin, followed by pressing a mold onto the coating of the thermoplastic polymer resin to transfer the pattern of the mold. In the photo nano-imprint method, a substrate is coated with a photo-curable composition and a mold is pressed on the coating, followed by irradiating light having a predetermined wavelength, e.g., UV rays, to cure the monomer contained in the composition to transfer the pattern of the mold. According to the photo nano-imprint method, the mold is made of a transparent material, such as, for example, quartz or glass, through which light such as UV rays can be transmitted. In the micro-contact printing (μCP) method, which is one of the most typically used soft lithographic processes, ink is applied to a surface of convex parts of a mold made of a silicone elastic polymer having a small surface tension, e.g., polydimethylsiloxane (PDMS), and the mold is then pressed on a substrate to transfer micropatterns to the substrate.

The nano-imprint lithography technique has the following advantages:

1) Since the nano-imprint lithography technique is based on a pressing technique, it can be technically simple and cheap.

2) Since a hard mold made of silicon or silicon dioxide is used, ultramicropatterns can be efficiently transferred over a large area in a repeated manner.

3) Since the critical resolution of transfer patterns is determined by pattern shapes of a mold, high throughput 3D micropatterns of about 5 nm scale can be easily transferred in a repeated manner.

However, the nano-imprint lithography technique has a problem in that it is not easy to release a mold from a substrate after pressing the mold onto the substrate without deformation of the polymer pattern layer formed on the substrate. That is to say, when the mold is separated from the substrate, the polymer pattern layer may adhere to the mold and thus may be partially lifted off with the mold, which may often result in damage to micropatterns transferred onto the substrate.

As described above, a poor releasing property between the mold and the polymer pattern layer on the substrate may damage the transferred polymer pattern layer due to the adhesion and may prevent the mold from being repeatedly used due to contamination. Therefore, enhancing the releasing property of the mold is a significant challenge in the nano-imprint lithography technique.

To address the issue associated with adhesion between the mold and the polymer pattern layer, the following nano-imprint lithography techniques have been proposed.

Korean Patent Registration No. 0568581 discloses a composition for a mold used in forming micropatterns, which comprises: (1) an active energy curable urethane-based oligomer having a reactive group selected from the group consisting of (meth)acrylate, vinylether, arylether, and a combination thereof; (2) a monomer reactive with the urethane-based oligomer, having a reactive group selected from the group consisting of (meth)acrylate, vinylether, arylether, and a combination thereof; (3) a silicone or fluorine containing compound; and (4) a photoinitiator. However, according to tests conducted by the present inventor, the photo-curable resin composition prepared in such a manner as disclosed in the above mentioned reference, has been found to have an insufficient releasing property, so that the composition is not advantageous for use in a nano-imprint lithographic process using a mold having a pattern depth of 100 nm or less. In detail, in a case where the photo-curable resin composition is subjected to a nano-imprint lithographic process using a nano-sized mold, when the mold is released after the photo-curing process, a surface of the mold may be contaminated by polymer fragments and some defects may also be produced in transferred patterns.

It is well known in nano-imprint lithography technology that in order to provide a good releasing property, a surface of a mold may be coated with silicone- or fluorine-based oil to reduce a surface tension of the mold, thus leading to a reduction in adhesion.

For example, Korean Patent Publication No. 2005-0071230 discloses a microstructure mold having an improved releasing property by forming on the surface of the mold a self-assembled monolayer (SAM) using a release agent having a surfactant and an organic solvent mixed with each other. In such methods using such a release agent layer, the release agent may be selected so as to not affect the shapes of the nano-sized patterns. Accordingly, the release agent layer may be selected to have a thickness of several nano meters or less. However, forming a separate release agent layer satisfying such a requirement prior to the formation of a polymer layer lowers productivity and increases production costs. In addition, unstable physical and chemical properties of the release agent used may contaminate the mold and/or substrate. Further, if the conventional photo-curable composition for forming the polymer pattern layer is used in nano-imprint lithography, the reliability and durability of the composition in terms of its adhesion and releasing properties with respect to the mold and/or substrate may not be ensured.

### SUMMARY OF THE INVENTION

Aspects of the present invention provide a photo-curable composition having excellent releasing property and pattern transfer property.

Additional aspects and/or advantages of the invention will be set forth in part in the description which follows and, in part, will be obvious from the description, or may be learned by practice of the invention.

Aspects of the present invention also provide a method for transferring a pattern using the photo-curable composition.

Aspects of the present invention also provide an optical recording medium having a polymer pattern layer produced using the photo-curable composition.

According to an embodiment of the present invention, there is provided a photo-curable composition comprising: 100 parts by weight of a urethane-polydimethylsiloxane copolymerization prepolymer formed by a reaction of a polyol having two or more hydroxyl groups in a molecule thereof, a reactive polydimethylsiloxane having at least one reactive group selected from the group consisting of an amino group, an epoxy group, a carboxy group, a hydroxy group, a halogen atom, a thiol group, and a (meth)acrylate group, in a side chain or terminal group thereof, and an aliphatic or aromatic polyisocyanate compound; 10-80 parts by weight of (meth)acrylate-based monomer having a functionality of 4 or less, based on 100 parts by weight of the urethane-polydimethylsiloxane copolymerization prepolymer, and 0.1-10 parts by weight of a photoinitiator, based on 100 parts by weight of the urethane-polydimethylsiloxane copolymerization prepolymer.

According to another embodiment of the present invention, there is provided a method of forming a patterned polymer layer on a substrate, the method comprising: forming a photo-curable composition coating on a substrate; imprinting the photo-curable composition coating by embedding a stamper having a predetermined pattern in the photo-curable composition; irradiating the photo-curable composition coating with light to cure the composition, while the stamper is embedded in the photo-curable composition coating; and separating the stamper from the photo-curable composition coating on the substrate, wherein the photo-curable composition comprises: 100 parts by weight of a urethane-polydimethylsiloxane copolymerization prepolymer formed by a reaction of a polyol having two or more hydroxyl groups in a molecule thereof, a reactive polydimethylsiloxane having at least one reactive group selected from the group consisting of an amino group, an epoxy group, a carboxy group, a hydroxy group, a halogen atom, a thiol group, and a (meth)acrylate group in a side chain or terminal group thereof, and an aliphatic or aromatic polyisocyanate compound; 10-80 parts by weight of (meth)acrylate-based monomer having the functionality of 4 or less, based on 100 parts by weight of the urethane-polydimethylsiloxane copolymerization prepolymer, and 0.1-10 parts by weight of a photoinitiator, based on 100 parts by weight of the urethane-polydimethylsiloxane copolymerization prepolymer.

According to still another embodiment of the present invention, there is provided an optical recording medium comprising: a substrate; and a recording layer formed on the substrate, wherein the recording layer comprises a polymer pattern layer including a recording mark having a predetermined pattern having a plurality of pits, the polymer pattern layer being formed by curing the photo-curable composition. As a non-limiting example, each of the plurality of pits may have a height ranging from about 20 nm to about 100 nm.

According to another aspect of the present invention, the photo-curable composition may further comprise 0.1-10 parts by weight of a mono-functional aliphatic thiol compound having a carbon number of 1 to 30, a mono-functional aliphatic alcohol compound having a carbon number of 1 to 30, or a mixture thereof, based on 100 parts by weight of the urethane-polydimethylsiloxane copolymerization prepolymer.

The photo-curable composition has an inherently excellent releasing property and a pattern transfer property. Accordingly, the use of the photo-curable composition can provide high reliability and durability and enhance the performance efficiency in repeatedly transferring nano- or micro-scale patterns.

In addition, the photo-curable composition according to aspects of the present invention requires no additional process before coating the same. For example, a low-molecular release agent layer coating process is not needed; thereby, problems caused by nonuniformity in coating a release agent layer or physical and chemical instabilities of the release agent layer are avoided.

Accordingly, the use of the photo-curable composition according to aspects of the present invention allows micropatterns to be efficiently transferred onto a substrate using a stamper having a predetermined pattern, and the stamper can be reused multiple times.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a cross-sectional diagram illustrating a pattern transfer method according to an embodiment of the present invention and a structure of an optical disc formed by the pattern transfer method;

FIG. 2A is an atomic force microscope (AFM) view of a plastic stamper used in the current embodiment, and FIG. 2B shows a pit depth profile of protrusion and non-protrusion patterns measured by scanning along the line “A” shown in FIG. 2A;

FIG. 3A is an AFM view of the polymer pattern layer formed on the substrate, and FIG. 3B shows a pit depth profile of protrusion and non-protrusion patterns measured by scanning along a particular line in the view shown in FIG. 3A;

FIG. 4A is an AFM view of the polymer pattern layer formed on a substrate after performing the 50^{th} imprinting, in which dark portions indicate pits formed by imprinting from the protrusion parts of the stamp, and FIG. 4B shows a pit depth profile of protrusion and non-protrusion patterns measured by scanning along a particular line in the view shown in FIG. 4A;

FIG. 5A is an atomic force microscope (AFM) view of a plastic stamper used in another embodiment, and FIG. 5B shows a pit depth profile of protrusion and non-protrusion patterns measured by scanning along the line “A” shown in FIG. 5A; and

FIG. 6A is an AFM view of the polymer pattern layer formed on a substrate, and FIG. 6B shows a pit depth profile of protrusion and non-protrusion patterns measured by scanning along the line “A” shown in FIG. 6A.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, the term “releasing property” indicates the extent to which a stamper used as a mold can be easily released from a transferred polymer pattern formed by curing a photo-curable composition without contamination of the stamper or deformation of the transferred pattern.

The photo-curable composition according to aspects of the present invention will be described in more detail below.

The photo-curable composition according to aspects of the present invention includes (a) 100 parts by weight of a urethane-polydimethylsiloxane copolymerization prepolymer formed by a reaction of i) a polyol having two or more hydroxyl groups in a molecule thereof, ii) a reactive polydimethylsiloxane having at least one reactive group selected from the group consisting of an amino group, an epoxy group, a carboxy group, a hydroxy group, a halogen atom, a thiol group, and (meth)acrylate, in the side chain or terminal group thereof, and iii) an aliphatic or aromatic polyisocyanate compound; (b) 10-80 parts by weight of (meth)acrylate-based monomer having a functionality of 4 or less, based on 100 parts by weight of the urethane-polydimethylsiloxane copolymerization prepolymer; and (c) 0.1-10 parts by weight of a photoinitiator, based on 100 parts by weight of the urethane-polydimethylsiloxane copolymerization prepolymer.

The urethane-polydimethylsiloxane copolymerization prepolymer is formed by a reaction of i) a polyol having two or more hydroxyl groups in a molecule thereof, ii) a reactive polydimethylsiloxane having at least one reactive group selected from the group consisting of an amino group, an epoxy group, a carboxy group, a hydroxy group, a halogen atom, a thiol group, and (meth)acrylate, in the side chain or terminal group thereof, and iii) an aliphatic or aromatic polyisocyanate compound.

Herein, the term “urethane-polydimethylsiloxane copolymerization prepolymer” refers to at least one of a polyurethane-polydimethylsiloxane copolymerization prepolymer, a polyamidoimide-polydimethylsiloxane copolymerization prepolymer and a polyurea-polydimethylsiloxane copolymerization prepolymer, formed by a reaction of the polyol component, the reactive polydimethylsiloxane component and the polyisocyanate compound. In the urethane-polydimethylsiloxane copolymerization prepolymer, the polyurethane, polyamidoimide and polyurea components improve an adhesion property of the photo-curable composition and increase a coating strength of the polymer pattern layer. The reactive polydimethylsiloxane component reduces a surface tension of the polymer pattern layer formed by photo-curing the photo-curable composition, thereby imparting an inherently excellent releasing property to the photo-curable composition. The use of the photo-curable composition according to aspects of the present invention allows a nano-scale pattern transfer process to be performed in a reliable, repeatable manner without the necessity of separately forming a release agent layer prior to forming of the polymer layer. Accordingly, the performance efficiency of nano-scale pattern transfer processes can be enhanced and the production cost can be reduced.

In the photo-curable composition, i) the polyol component, ii) the reactive polydimethylsiloxane component and iii) the polyisocyanate compound are preferably in a weight ratio in a range of 30˜70% by weight: 15˜65 by weight: 5˜20% by weight. When the amount of the polyol component is less than 30% by weight and the amount of the polyisocyanate compound exceeds 20% by weight, elasticity of the polymer pattern layer may decrease. When the amount of the polyol component exceeds 70% by weight and the amount of the polyisocyanate compound is less than 5% by weight, the mechanical strength of the polymer pattern layer may become inferior. When the amount of reactive polydimethylsiloxane component is less than 15% by weight, the enhancing effect of the releasing property and pattern transfer property intended by the present invention may become insufficient. When the amount of the reactive polydimethylsiloxane component exceeds 65% by weight, it may become difficult to adjust the physical properties of the photo-curable composition. That is to say, the viscosity of the composition may become extremely high and the adhesion strength may become very poor.

The polyol may be a polyether-based polyol, a polyester-based polyol, or a mixture thereof.

Specific examples of the polyether-based polyol include polyethylene glycol, polypropylene glycol, polytetramethylene glycol, and so on. Specific examples of the polyester-based polyol include polyethylene adipate, polybutylene adipate, polypropylene adipate, polycaprolactone, and so on.

The reactive polydimethylsiloxane includes at least one reactive group selected from the group consisting of an amino group, an epoxy group, a carboxy group, a hydroxy group, a halogen atom, a thiol group, and (meth)acrylate, in the side chain or terminal group thereof. The number of reactive groups present in a molecule of the reactive polydimethylsiloxane is not particularly restricted and may be at least one, preferably at least two or three. For example, the reactive polydimethylsiloxane may be at least one compound represented by the following formulas (1) through (4):

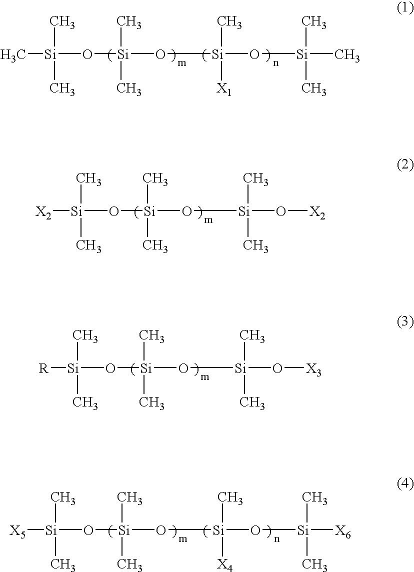

wherein m and n may be the same or different, each independently representing an integer from 1 to 20, preferably from 1 to 10;

X₁-X₆ may be the same or different, each independently representing at least one reactive group represented by the following formulas:

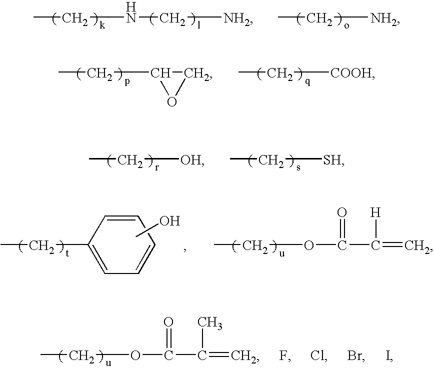

wherein k, l, o, p, q, r, s, t, and u are independently an integer from 0 to 10, preferably from 1 to 5, which are the same or different, and

R is an alkyl or alkoxy group having a carbon number of 1 to 10, preferably an alkyl or alkoxy group having a carbon number of 1 to 5, more preferably an alkyl or alkoxy group having a carbon number of 1 to 3.

If m, n, k, l, o, p, q, r, s, t and u exceed the values enumerated above, the viscosity of the photo-curable composition may increase.

From the standpoint of availability and economic feasibility, the reactive polydimethylsiloxane may be at least one compound represented by the following formulas (5) through (7):

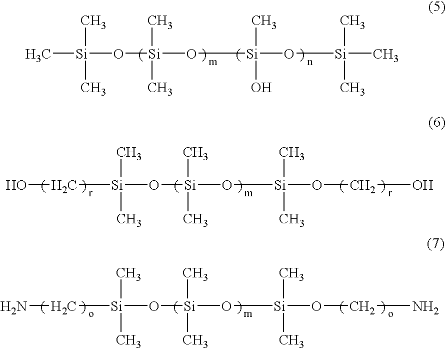

where m, n, o, and r are the same as defined above.

Examples of the polyisocyanate compound include isophorone diisocyanate, 1,6-hexamethylene diisocyanate 1,8-octamethylene diisocyanate, 1,6-hexamethylene diisocyanate trimer, 4,4′-dicyclohexylmethane diisocyanate, 4,4′-diphenylmethane diisocyanate, 3,3′-dimethyl-4,4′-biphenylene diisocyanate, 3,3′-dimethyidiphenylmethane-4,4′-diisocyanate, 4-bromo-6-methyl-1,3-phenylene diisocyanate, 4-chloro-6-methyl-1,3-phenylene diisocyanate, poly(1,4-butanediol)tolylene 2,4-diisocyanate, poly(1,4-butanediol) isophorone diisocyanate, poly(ethyleneadipate)tolylene-2,4-diisocyanate, 2,4-toluene diisocyanate, 2,5-toluene diisocyanate, 2,6-toluene diisocyanate, 1,5-naphthalene diisocyanate, and so on.

The (meth)acrylate-based monomer having a functionality of 4 or less is a component for adjusting a viscosity of the photo-curable composition and imparting photo-curability to the composition. The term “functionality” with respect to the (meth)acrylate-based monomer refers to the number of double bonds present in the monomer. The functionality of the monomer is 4 or less, preferably 2 to 4, more preferably 2 to 3. If the functionality is greater than 4, the crosslinking density may be substantially increased during a photo-curing process, so that the hardness and brittleness of the polymer pattern layer may overly increase. The content of the (meth)acrylate-based monomer is preferably about 10 to 80 parts by weight based on 100 parts by weight of the urethane-polydimethylsiloxane copolymerization prepolymer. If the content of the (meth)acrylate-based monomer is less than 10 parts by weight, the viscosity of the photo-curable composition may become too high, so that it may be difficult to handle the composition and the crosslinking density during photo-curing may be lowered, resulting in an increase of the photo-curing processing time. If the content of the (meth)acrylate-based monomer exceeds 80 parts by weight, the viscosity of the photo-curable composition may become too low, which also may make it difficult to handle the composition, and the crosslinking density during the photo-curing process may become overly increased, which may extremely increase the hardness and brittleness of the polymer pattern layer.

Specific examples of the (meth)acrylate-based monomer having a functionality of 4 or less include mono-functional monomers exemplified by 2-hydroxyethyl (meth)acrylate, hydroxypropyl (meth)acrylate, hydroxybutyl (meth)acrylate, hydroxypentyl (meth)acrylate, and hydroxyhexyl (meth)acrylate; di-functional monomers exemplified by 1,6-hexanediol di(meth)acrylate, triphenyl glycol diacrylate, butanediol diacrylate, 1,3-butylene glycol di(meth)acrylate, neopentyl glycol diacrylate, ethyleneglycol diacrylate, dimethyl glycol di(meth)acrylate, triethylene glycol diacrylate, polyethylene glycol di(meth)acrylate, dipropylene glycol diacrylate, dipropylene glycol allyl ether methacrylate, and methoxylated neopentyl glycol diacrylate; tri- or tetra-functional monomers exemplified by trimethylolpropane tri(meth)acrylate, pentaerythritol triacrylate, epoxylated trimethylolpropane triacrylate, propylated trimethylolpropane triacrylate, glyceryl propylated triacrylate, tris(2-hydroxymethyl) isocyanurate triacrylate, and pentaerythritol tetraacrylate.

The photoinitiator may be a conventional free radical initiator, a cationic initiator, or a mixture thereof. To simplify the reaction process, a free radical initiator is preferably used. The free radical initiator produces radicals by UV light irradiation to initiate a photopolymerization of the (meth)acrylate-based monomer having 4 or less functional groups and crosslinking reactions between the (meth)acrylate-based monomer and other components. The photoinitiator is preferably present in an amount of less than or equal to about 0.1 to about 10 parts by weight, with respect to 100 parts by weight of the urethane-polydimethylsiloxane copolymerization prepolymer. If the amount of the photoinitiator is smaller than 0.1 parts by weight, the time required to complete the photopolymerization may be considerably extended. If the amount of the photoinitiator exceeds 10 parts by weight, it may be quite difficult to control the heat of polymerization.

Specific examples of the photoinitiator used according to aspects of the present invention include at least one free radical initiator selected from the group consisting of benzyl ketals, benzoin ethers, acetophenone derivatives, ketoxime ethers, benzophenones, benzo and thioxanthone compounds, and mixtures thereof, but it is not limited to these compounds. Any compound that it is activated by UV radiation to act as a photoinitiator may be used. The free radical photoinitiator produces free radicals when irradiated with UV light, and the free radicals attack double bonds of the (meth)acrylate monomer having 4 or less functional groups to cause a photopolymerization of the (meth)acrylate-based monomer and a crosslinking reaction between the (meth)acrylate-based monomer and other components. The photopolymerization and crosslinking reactions sharply increase the molecular weight of the photo-curable composition, resulting in a loss of flowability, thereby forming a polymer pattern layer having the micropatterns of the stamper transferred thereon.

The photo-curable composition according to the present invention may further comprise an aliphatic thiol compound having a carbon number of 1 to 30, preferably an aliphatic thiol compound having a carbon number of 3 to 20 and/or an aliphatic alcohol compound having a carbon number of 1 to 30, preferably an aliphatic alcohol compound having a carbon number of 3 to 20, in an amount of about 0.1 to about 10 parts by weight. These compounds are contained in an amount of about 0.1 to about 10 parts by weight, preferably about 0.1 to about 5 parts by weight, with respect to 100 parts by weight of the urethane-polydimethylsiloxane copolymerization prepolymer. These compounds may form a self-assembled monolayer on a surface of a stamper used as the mold to thereby enhance a releasing property of the substrate. Specific examples of the thiol and alcohol compounds include propyl mercaptan, butyl mercaptan, lauryl mercaptan, stearyl mercaptan, propyl alcohol, butyl alcohol, cetyl alcohol, lauryl alcohol, or stearyl alcohol, but not limited thereto.

The photo-curable composition according to aspects of the present invention may further comprise various known additives, e.g., a stabilizer, an antioxidant, a thermal curing inhibiter, a surfactant, a leveling agent, or the like, in each appropriate amount, if necessary.

Next, a preparation method of the photo-curable composition according to aspects of the present invention will be described.

First, a polyol having two or more hydroxyl groups per molecule, a reactive polydimethylsiloxane, and an aliphatic or aromatic polyisocyanate compound are mixed and stirred to carry out a reaction to form a polyurethane prepolymer. During this reaction, the polyisocyanate compound reacts with a hydroxyl group of the polyol and a reactive group of the reactive polydimethylsiloxane, thereby forming the prepolymer referred to herein the sake for convenience as the “urethane-polydimethylsiloxane copolymerization prepolymer” i As non-limiting examples, the formed urethane-polydimethylsiloxane copolymerization prepolymer may be a polyurethane-polydimethylsiloxane copolymerization prepolymer, a polyamidoimide-polyurethane-polydimethylsiloxane copolymerization prepolymer, or a polyurea-polydimethylsiloxane copolymerization prepolymer.

The polyurethane prepolymer formation reaction may be carried out in a bulk state without using a solvent. The reaction temperature may be adjusted to be in a range of about room temperature to about 70° C., preferably from about 30° C. to about 60° C. As the reaction temperature becomes higher, the reaction is expedited. The reaction time may be in a range of about 1 hour to about 12 hours, preferably from about 1 hour to about 6 hours. If the reaction time is too long or the reaction temperature is too high, side reactions may undesirably occur.

The mixing ratio of the polyol component: the reactive polydimethylsiloxane : the polyisocyanate compound may be controlled to be 30˜70% by weight: 15˜65% by weight: 5˜20% by weight. The obtained urethane-polydimethylsiloxane copolymerization prepolymer has excellent coating strength and adhesion derived from polyurethane, polyamidoimide and/or polyurea component and an excellent releasing property derived from the polydimethylsiloxane component.

Subsequently, based on 100 parts by weight of the formed urethane-polydimethylsiloxane copolymerized prepolymer, 10 to 80 parts by weight of the (meth)acrylate-based monomer having a functionality of 4 or less is added to the prepolymer at a temperature in a range of about room temperature to about 60° C., preferably from about room temperature to about 40° C., and the resulting mixture is stirred for homogenization. A stirring time for homogenization is not particularly limited, but a duration ranging from about 0.5 to about 2 hours is sufficient.

Meanwhile, if the photo-curable composition according to aspects of the present invention contains an aliphatic thiol compound and/or aliphatic alcohol compound that forms a self-assembled monolayer (SAM), while or after the (meth)acrylate-based monomer is mixed, the aliphatic thiol compound and/or aliphatic alcohol compound is added at a temperature in a range of about room temperature to about 40° C., preferably from about room temperature to about 25° C., and homogenized. Here, the thiol compound and/or aliphatic alcohol compound is mixed in an amount of 0.1 to 10 parts by weight, based on 100 parts by weight of the urethane-polydimethylsiloxane copolymerization prepolymer. A stirring time for homogenization is not particularly limited, but a duration ranging from about 0.5 to about 2 hours is sufficient.

Finally, 0.1 to 10 parts by weight of a photoinitiator is added to the resultant mixture at a temperature in a range of about room temperature to about 40° C., preferably from about room temperature to about 25° C., and homogenized. A stirring time for homogenization is not particularly limited, but a duration ranging from about 0.5 to about 2 hours is sufficient.

After all of the components of the composition are mixed together, the composition is degassed using a general degassing technique, e.g., pumping.

Next, a method for transferring a pattern using the photo-curable composition according to aspects of the present invention will be described.

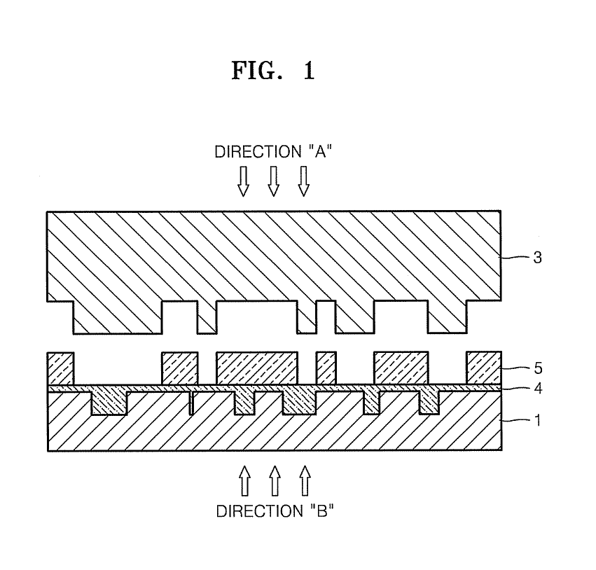

FIG. 1 is a cross-sectional diagram illustrating a pattern transfer method according to an embodiment of the present invention and a structure of an optical disc formed by the pattern transfer method.

In order to increase reflectivity, a metal layer 4 is first formed on a substrate 1 having a predetermined pit pattern, which is generally referred to as an “L0 recording layer” by one skilled in the art, by a common technique, e.g., sputtering. The substrate 1 may be appropriately selected from an amorphous polyolefin film, a polyester film, a polycarbonate film or an acryl resin film such as a polymethyl methacrylate film, or a glass substrate, according to the use. Preferably, the substrate 1 is transparent, so that irradiated light is not prevented from reaching the photo-curable composition. The metal layer 4 may be made of gold (Au), silver (Ag), nickel (Ni), copper (Cu), or an Ag-based alloy. The thickness of the metal layer 4 is generally 200 nm or less, preferably 100 nm or less. From the standpoint of reflectivity and adhesion, an Ag-based alloy is preferably used as the metal layer 4. The Ag-based alloy may be a Ag—Pd—Cu (APC) alloy. Particularly, the Ag—Pd—Cu (APC) alloy preferably contains 90˜99% by weight of Ag, 0.5˜5% by weight of Pd, and 0.5˜5% by weight of Cu. As a specific, non-limiting example, the APC alloy may contains 98% by weight of Ag, 1% by weight of Pd, and 1% by weight of Cu.

Subsequently, the photo-curable composition coating (not shown) according to aspects of the present invention is coated on the metal layer 4. The coating method is not particularly limited and a spin coating method may be used.

Next, a stamper 3 having a predetermined pattern is prepared. The stamper 3 is used to transfer patterns in a large quantity using an imprint method. A method of manufacturing a stamper by photolithography to have a predetermined pattern is well known in the art. (The stamper 3 may also be referred to in the art as a die or a mold.) The predetermined pattern of the stamper 3 is installed to face the substrate 1 to allow the substrate 1 and the stamper 3 to face each other, a photo-curable composition coating on the substrate 1 is imprinted using the stamper 3 as a mold.

Next, the photo-curable composition coating is irradiated with light to cure the composition while the stamper 3 is embedded in the photo-curable composition coating. At least one of the substrate 1 and the stamper 3 may be transparent such that light may be irradiated through the substrate 1 or the stamper 3 to cure the photo-curable composition. If both the substrate 1 and the stamper 3 are transparent, light may be irradiated through at least one of the substrate 1 and the stamper 3 (for example, in either direction “A” or “B”) to cure the photo-curable composition. The irradiated light passes through the stamper 3 and/or the substrate 1 to reach the photo-curable composition and initiates photopolymerization of the composition.

The light used for photo-curing the photo-curable composition may be selected according to the kind of photo-polymerizable monomer, prepolymer or a photoinitiator, and may include UV light, visible light, an IR ray, an electron beam, and so on.

The predetermined pattern of the stamper 3 is transferred to the photo-curable composition coating by curing using photo-polymerization to form the polymer pattern layer 5 on the substrate 1.

Finally, the stamper 3 is separated from the polymer pattern layer 5, thereby completing the formation of the polymer pattern layer 5 having the pattern of the stamper 3 transferred thereon. Here, convex parts of the stamper 3 are transferred to form concave parts (pits) in the polymer pattern layer 5. That is to say, a positive image of the stamper 3 is transferred to a negative image on the substrate 1.

When manufacturing a high-density optical recording medium having a plurality of recording layers, such as a multi-layered optical disc, in order to increase the reflectivity, a dielectric layer (not shown) may be formed on the polymer pattern layer 5 and then another polymer pattern layer may then be formed by the above-described imprinting method on the dielectric layer, which is repeatedly performed. The thickness of the dielectric layer may vary according to the kind of material used, and may be in the range of 500 nm or less, preferably 300 nm or less, more preferably 200 nm or less, and still more preferably 150 nm or less.

When the method for transferring a pattern according to aspects of the present invention is used to form a recording layer of an optical recording medium or a magnetic recording medium, the pattern of the stamper may consist of a plurality of convex projections having a height in a range of about 20 nm to about 100 nm, preferably from about 50 nm to about 100 nm, more preferably from about 50 nm to about 80 nm. Accordingly, information recording marks having a predetermined pattern consisting of a plurality of pits are formed on the polymer pattern layer 5 on the substrate 1 by imprinting the photo-curable composition coating using the stamper. Here, the pit depth is in a range of about 20 nm to about 100 nm, preferably from about 50 nm to about 100 nm, more preferably from about 50 nm to about 80 nm.

The obtained optical recording medium according to aspects of the present invention, as shown in FIG. 1, includes a substrate 1, and a recording layer formed on the substrate 1. The recording layer is a polymer pattern layer 5 having information recording marks having a predetermined pattern consisting of a plurality of pits having a pit depth in the range of about 20 nm to about 100 nm, preferably from about 50 nm to about 100 nm. The polymer pattern layer 5 is formed by curing the photo-curable composition according to aspects of the present invention.

A pre-formed pattern of the LO recording layer may be provided on a surface of the substrate 1, as indicated by concave and convex patterns on the substrate 1 in FIG. 1. When manufacturing a high-density optical recording medium having a plurality of recording layers, such as a multi-layered optical disc, a dielectric layer (not shown) may be formed on the polymer pattern layer 5 (L1 recording layer) by a well-known method, such as sputtering, and another polymer pattern layer (not shown) may then be formed by the above-described imprinting method, which is repeatedly performed. The dielectric layer serves as a thermal and mechanical passivation layer and is made of at least one oxide, nitride, carbide, sulfide or fluoride material. Specific examples of these materials include silicon oxide (SiOₓ), magnesium oxide (MgOₓ), aluminum oxide (AlOₓ), titanium oxide (TiOₓ), vanadium oxide (VOₓ), chromium oxide (CrOₓ), nickel oxide (NiOₓ), zirconium oxide (ZrOₓ), germanium oxide (GeOₓ), zinc oxide (ZnOₓ), silicon nitride (SiNₓ), aluminum nitride (AlNₓ), titanium nitride (TiNₓ), zirconium nitride (ZrNₓ), germanium nitride (GeNₓ), silicon carbide (SiC), zinc sulfide (ZnS), a zinc sulfide-silicon dioxide compound (ZnS—SiO₂), and magnesium fluoride (MgF₂). When the dielectric layer is made of a zinc sulfide-silicon dioxide compound (ZnS—SiO₂), the best properties can be exhibited when the compound has a molar ratio of ZnS to SiO₂ of 8:2.

As will be described below in detail, the use of the photo-curable resin composition according to embodiments of the present invention, which has excellent releasing property and pattern transfer property, enables nano-sized patterns to be transferred onto substrates repeatedly at least 50 times using a stamper having a predetermined pattern without deformation in the pattern.

That is to say, a polymer pattern layer obtained after performing the 50th imprinting process has substantially the same information reproduction property as a polymer pattern layer obtained after performing the first imprinting process using a stamper having the same pattern. Therefore, the method of transferring patterns using the photo-curable resin composition according to aspects of the present invention can be used to efficiently manufacture a high-density optical recording medium or magnetic recording medium in an improved throughput. The transferred patterns may be the same or different.

Aspects of the present invention will be described in more detail with reference to the following examples. It will be understood that these Examples are provided for descriptive purposes only and not for purposes of limitation.

Preparation of Photo-curable Compositions A through F

Photo-curable compositions A through F having compositions and contents shown in Table 1 were prepared. First, polypropylene glycol (LAPROL 3000), polydimethylsiloxane having both terminal groups blocked with hydroxyl groups (X-22-160C), 1,6-hexamethylene diisocyanate (HMDI) and 1,6-hexamethylene isocyanate trimer (CORONATE HX) were mixed in a reaction vessel equipped with an agitator and temperature-controlled by a water jacket. The mixture was well agitated to react at 30° C.˜35° C. for 4 hours, yielding a urethane-polydimethylsiloxane copolymerization prepolymer. While maintaining the copolymerization prepolymer at about 40° C. to 42° C., 1,6-hexanediol diacrylate (HDDA), hydroxypropyl methacrylate, trimethoxy propyl tetraacrylate, hydroxyethyl acrylate, and 2-hydroxyethyl methacrylate (HEMA) were added and stirred for about 2 hours to be well mixed together. To the resultant mixture was added polydimethylsiloxane having secondary hydroxyl groups (DC-1248) at room temperature, followed by stirring for about 1 hour. Finally, a photoinitiator (IRGACURE 907) was added to the resultant product at room temperature and the resultant mixture was then stirred for another 1 hour, followed by degassing using a vacuum pump, thereby preparing the desired photo-curable compositions A through F (compositions E and F are comparative examples).

TABLE 1
(Unit: parts by weight)

| | Composition A | Composition B | Composition C | Composition D | Composition E | Composition F |
|---|---|---|---|---|---|---|
| Polypropylene glycol | 30 | 33 | 27.2 | 20.4 | 28 | 35 |
| (LAPROL 3000)#1 | | | | | | |
| Dimethylsiloxane | 2 | 6 | 40.8 | 25.7 | 8 | 2 |
| having secondary | | | | | | |
| hydroxyl groups | | | | | | |
| (DC-1248)#2 | | | | | | |
| Polydimethylsiloxane | 10 | 6 | 4.5 | 5 | — | 1.5 |
| having both terminals | | | | | | |
| groups blocked with | | | | | | |
| hydroxyl groups | | | | | | |
| (X-22-160C)#3 | | | | | | |
| 1,6-hexamethylene | 8.5 | 6.8 | 4.5 | 8.5 | 7.5 | 9.5 |
| diisocyanate (HMDI) | | | | | | |
| 1,6-hexamethylene | 0.2 | 1 | 0.2 | 0.2 | 2 | 1.8 |
| Diisocyanate trimer | | | | | | |
| (CORONATE HX)#4 | | | | | | |
| 1,6-hexanediol | 20.5 | 10 | 13 | 10.5 | 18 | 20 |
| diacrylate (HDDA) | | | | | | |
| Hydroxypropyl | 3 | 5.6 | 3 | — | 5.5 | 4.8 |
| methacrylate | | | | | | |
| Trimethoxypropyl | 2.6 | 13 | — | 9 | 8 | 7.5 |
| tetraacrylate | | | | | | |
| Hydroxyethyl | 2 | 5.7 | 3 | 4.5 | 2.5 | 1.8 |
| Acrylate | | | | | | |
| 2-hydroxyethyl | 6.7 | 6.7 | — | 11 | 2 | 8.1 |
| Methacrylate | | | | | | |
| (HEMA) | | | | | | |
| Photoinitiator | 2.7 | 4 | 2.7 | 2.7 | 1.5 | 8 |
| (IRGACURE 907)#5 | | | | | | |

#1Commercially available from Hitachi Chemical Co., Ltd
#2Commercially available from Dow Corning
#3Commercially available from Shinetsu Chemical Co., Ltd
#4Commercially available from Degussa GmbH
#5Commercially available from Ciba Specialty Chemicals

### EXAMPLE 1

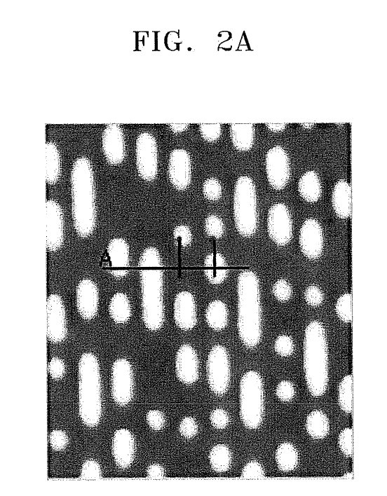

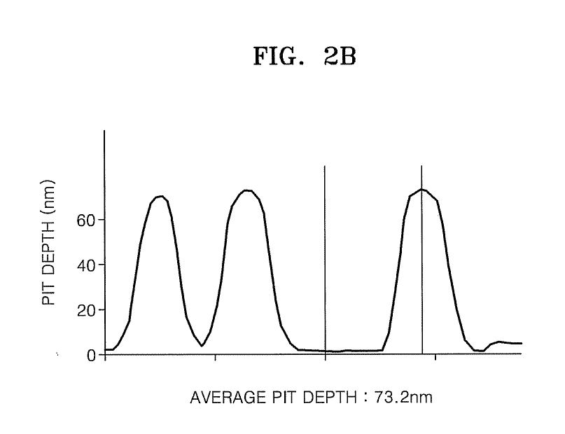

An optical disc was manufactured by transferring multi-layered patterns onto a substrate using a plastic stamper as a mold, prefabricated by a general method and using the photo-curable resin composition A. FIG. 2A is an atomic force microscope (AFM) view of the plastic stamper used in the current embodiment. In FIG. 2A, bright portions indicate a plurality of convex parts for forming pit patterns on the substrate. FIG. 2B shows a pit depth profile of protrusion and non-protrusion patterns measured by scanning along the line “A” shown in FIG. 2A. In the stamper, an average pit depth scanned along the line “A” was 73.2 nm. The AFM view and pit depth profile were obtained using an Autoprobe M5 manufactured by Park Scientific Instrument.

An Ag—Pd—Cu (APC) alloy layer having an average thickness of about 30 nm was formed by a vacuum deposition process on an L0 recording layer having a predetermined pattern formed on a surface of a circular polycarbonate transparent substrate having a thickness of 1.1 mm and a diameter of about 12 cm. The APC alloy contained 98% by weight of Ag, 1% by weight of Pd, and 1% by weight of Cu.

Next, 1.2 g of photo-curable composition A was applied on the alloy layer by spin coating. Here, a rotation speed of a spin coater was adjusted to about 4,000 rpm so that the photo-curable composition A was formed with a film thickness in a range of about 20 to about 30 μm.

Subsequently, a layer of the photo-curable composition A coated on the substrate was imprinted using the stamper. Then, the photo-curable composition A was cured by irradiating UV light having a wavelength in a range of about 200 to about 450 nm with an energy of about 2,000 mJ/cm² for 10 seconds and the stamper was then separated from the substrate, thereby forming a polymer pattern layer on the substrate.

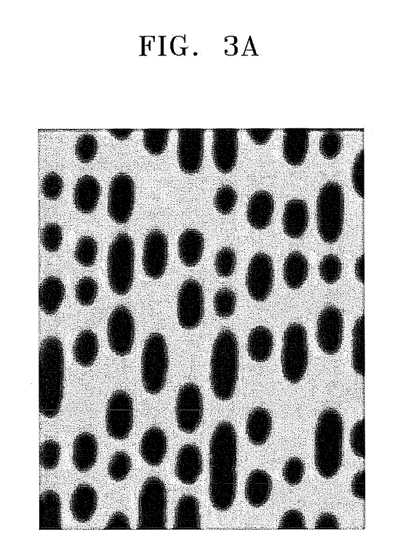

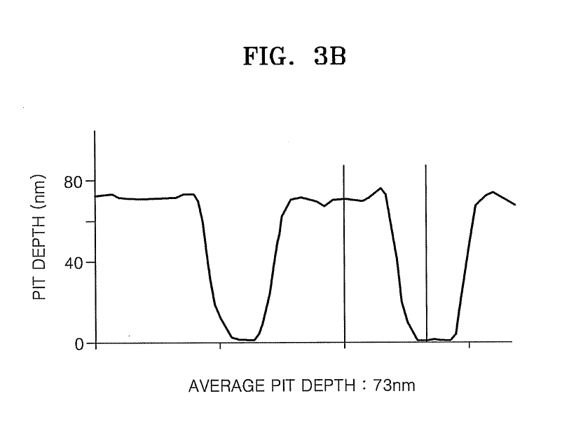

FIG. 3A is an AFM view of the polymer pattern layer formed on the substrate after performing the first imprinting. In FIG. 3A, dark portions indicate pits formed by imprinting from the protrusion parts of the stamp. FIG. 3B shows a pit depth profile of protrusion and non-protrusion patterns measured by scanning along a particular line in the view shown in FIG. 3A. In the polymer pattern layer, an average pit depth scanned along the particular line was 73 nm. The AFM view and pit depth profile were obtained using an Autoprobe M5 manufactured by Park Scientific Instrument.

For the transfer patterns shown in FIG. 3A, jitter was measured by a time interval analyzer (TA 720, Yokogawa Electric Corporation). The measured jitter was 8.1%.

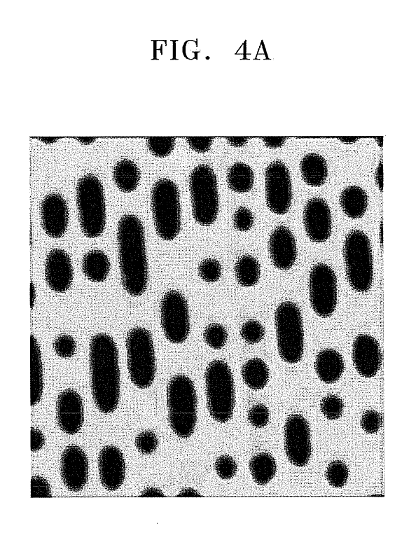

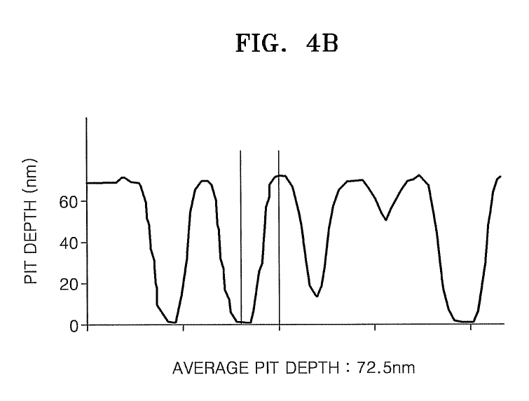

The nano-sized pattern transfer test was repeated 50 times on optical disks substrates coated with the photo-curable composition A using the same the stamper. FIG. 4A is an AFM view of the polymer pattern layer formed on the substrate after performing the 50th imprinting with the same stamper. In FIG. 4A, dark portions indicate pits formed by imprinting from the protrusion parts of the stamp. FIG. 4B shows a pit depth profile of protrusion and non-protrusion patterns measured by scanning along a particular line in the view shown in FIG. 4A. The average pit depth of the polymer pattern layer was 72.5 nm. For the transfer patterns shown in FIG. 4A, jitter was measured by a time interval analyzer (TA 720, Yokogawa Electric Corporation). The measured jitter was 8.1%.

A pit depth and jitter of the polymer pattern layer formed after performing the first nano-sized pattern transfer test were substantially the same as those of the polymer pattern layer formed after performing the 50^{th} nano-sized pattern transfer test.

In addition, even after performing the imprinting 50 times, no contamination was observed on the stamper. Further, substantial deformation of the polymer pattern layer, which may occur if a polymer composition has a poor releasing property and transfer property, was not observed while performing the 50 times of imprinting.

Next, in manufacturing an optical recording medium having a plurality of recording layers, such as, for example, a five-layered optical disc, using the photo-curable composition A as an imprint resin, there is a possibility that the photo-curing process may cause shrinkage of the imprint resin. Tilting of the disc occurring in such a case was evaluated as a tilt characteristic. To test for tilting, the APC alloy layer was formed on the L0 recording layer, a dielectric layer made of a zinc sulfide-silicon dioxide compound (ZnS-SiO₂) having an average thickness of about 130 nm was formed between each of L1 through L5 recording layers (i.e., polymer pattern layers, each successively formed as described above). The tilt characteristic was evaluated by measuring radial tilts and tangential tilts using a tester devised by the present inventors. Table 2 shows measurement results of the tilts.

TABLE 2

| | Location of measurement | | | | | |
|---|---|---|---|---|---|---|
| | L0 layer | | L5 layer | | Δ | |
| | Radial | Tangential | Radial | Tangential | Radial | Tangential |
| Radius | tilt | tilt | tilt | tilt | tilt | tilt |
| (mm) | (deg) | (deg) | (deg) | (deg) | (deg) | (deg) |
| 25 | 0.233 | 0.067 | 0.167 | 0.067 | 0.067 | 0 |
| 30 | 0.267 | 0.067 | 0.233 | 0.067 | 0.033 | 0 |
| 35 | 0.267 | 0.067 | 0.300 | 0.067 | 0.033 | 0 |
| 40 | 0.300 | 0.067 | 0.333 | 0.067 | 0.033 | 0 |
| 45 | 0.300 | 0.067 | 0.367 | 0.067 | 0.067 | 0 |
| 50 | 0.333 | 0.067 | 0.367 | 0.067 | 0.033 | 0 |
| 55 | 0.367 | 0.067 | 0.367 | 0.067 | 0 | 0 |

As confirmed from Table 2, when tilt values of L0 and L5 layers were compared, a difference between the tilt values between the L0 and L5 layers was less than 0.1 deg (°), suggesting that the tilt characteristic of the disc having recording layers prepared with the composition A was excellent.

### EXAMPLE 2

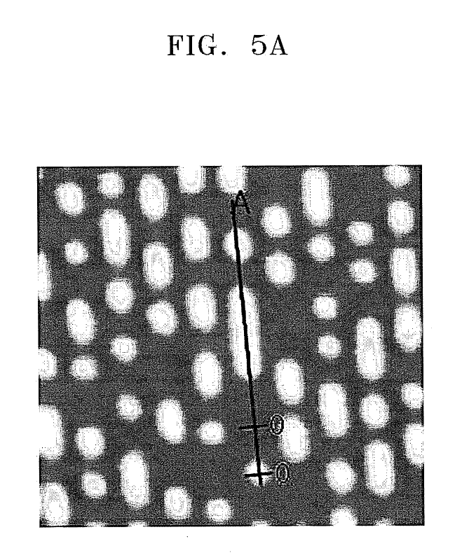

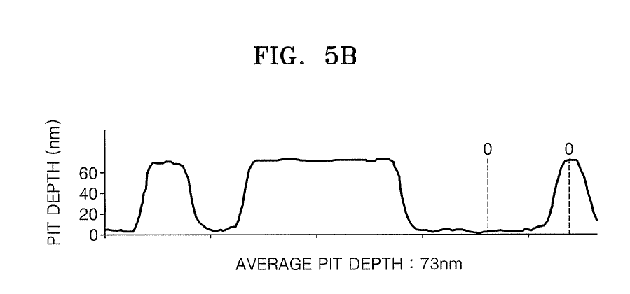

An optical disc was manufactured by transferring multi-layered patterns onto a substrate using a plastic stamper as a mold prefabricated by a general method and using the photo-curable resin composition B in the same manner as described in Example 1. FIG. 5A is an atomic force microscope (AFM) view of a plastic stamper used in the current example. In FIG. 5A, bright portions indicate a plurality of convex parts for forming pit patterns on the substrate. FIG. 5B shows a pit depth profile of protrusion and non-protrusion patterns measured by scanning along the line “A” shown in FIG. 5A. In the stamper, an average pit depth scanned along the line “A” was 73 nm. The AFM view and pit depth profile were obtained using an Autoprobe M5 manufactured by Park Scientific Instrument.

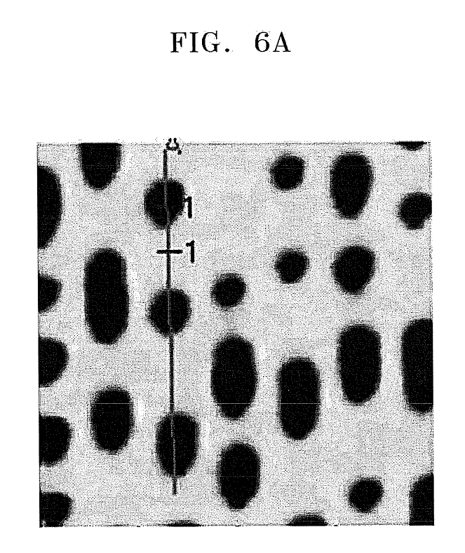

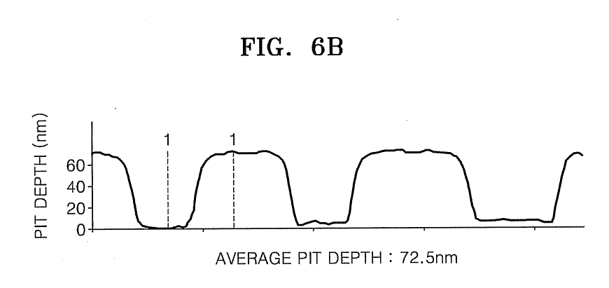

FIG. 6A is an AFM view of the polymer pattern layer formed on the substrate after performing the 50th imprinting on the photo-curable composition B using the same stamper. In FIG. 6A, dark portions indicate pits formed by imprinting from the protrusion parts of the stamp. FIG. 6B shows a pit depth profile of protrusion and non-protrusion patterns measured by scanning along the line “A” shown in FIG. 6A. An average pit depth scanned along the line was 72.5 nm. Even after performing the 50th imprinting, no contamination was observed on the stamper. Further, appreciable deformation of the polymer pattern layer was not observed while performing the imprinting 50 times.

With regard to jitter values, measurements after performing the first and the 50th imprinting were both 8.2%, as measured by the same tester used in Example 1. As to the tilt characteristic in case of recording using a five-layered optical disc, substantially the same evaluation result as in Example 1 was obtained.

### EXAMPLE 3

An optical disc was manufactured by transferring multi-layered patterns onto a substrate using the plastic stamper used in Example 1 and using the photo-curable resin composition C in the same manner as described in Example 1.

Even after performing the 50th imprinting, no contamination was observed from the stamper. Further, appreciable deformation of the polymer pattern layer was not observed while performing the imprinting 50 times.

With regard to jitter values, measurements after performing the first and the 50th imprintings were both 7.9%, as measured by the same tester used in Example 1. As to the tilt characteristic in case of recording using a five-layered optical disc, substantially the same evaluation result as in Example 1 was obtained.

### EXAMPLE 4

An optical disc was manufactured by transferring multi-layered patterns onto a substrate using the plastic stamper used in Example 1 and using the photo-curable resin composition D in the same manner as described in Example 1.

Even after performing the 50th imprinting, no contamination was observed on the stamper. Further, appreciable deformation of the polymer pattern layer was not observed while performing the imprinting 50 times.

With regard to jitter values, measurements after performing the first and the 50th imprintings were both 8.2%, as measured by the same tester used in Example 1. As to the tilt characteristic in case of recording using a five-layered optical disc, substantially the same evaluation result as in Example 1 was obtained.

### COMPARATIVE EXAMPLE 1

Patterns were transferred onto a substrate using the plastic stamper used in Example 1 in the same manner as described in Example 1, except that the photo-curable resin composition E, instead of the photo-curable resin composition A, was used.

However, unlike the photo-curable resin compositions of Examples 1 through 4, the photo-curable resin compositions of Comparative Example 1 demonstrated a poor release property and a poor pattern transfer property with respect to the stamper. That is to say, the surface of the stamper was contaminated by polymer fragments, and some of the polymer pattern layers formed on the substrate were partially deformed.

### COMPARATIVE EXAMPLE 2

Patterns were transferred onto a substrate using the plastic stamper used in Example 1 in the same manner as described in Example 1, except that the photo-curable resin composition F, instead of the photo-curable resin composition A, was used.

However, unlike the photo-curable resin compositions of Examples 1 through 4, the photo-curable resin compositions of Comparative Example 2 demonstrated a poor release property and a poor pattern transfer property with respect to the stamper. That is to say, the surface of the stamper was contaminated by polymer fragments, and some of the polymer pattern layers formed on the substrate were partially deformed.

By contrast, the photo-curable resin compositions according to Examples 1 through 4 are excellent in their release property and pattern transfer property. Accordingly, even ultramicropatterns, such as nano-sized patterns, can be efficiently transferred in a repeated manner by an imprinting method. Therefore, the photo-curable resin composition according to aspects of the present invention can greatly improve the throughput of high-density optical discs. On the other hand, in Comparative Examples 1 in which a reactive polydimethylsiloxane was not used or in Comparative Example 2, in which a low-content photo-curable composition was used, the pattern transfer and release properties of the photo-curable resin compositions were not good enough to efficiently transfer nano-sized patterns.

The photo-curable composition and a method for transferring a pattern using the same can be used in the manufacture of an optical or magnetic recording medium such as a compact disc, a digital versatile disc (DVD) or a magnetic disc, a semiconductor device, a display device, an ultramicro device, and so on.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the photo-curable composition may be used in forming a variety of micro-or nano-patterned objects by impressing the photo-curable composition with a stamper, die or mold having a pattern and then curing the photo-curable composition and removing the stamper, die or mold. Accordingly, it is intended, therefore, that the present invention not be limited to the various example embodiments disclosed, but that the present invention includes all embodiments falling within the scope of the appended claims.

What is claimed is:

1. A photo-curable composition comprising:
100 parts by weight of a urethane-polydimethylsiloxane copolymerization prepolymer formed by a reaction of a polyol having two or more hydroxyl groups in a molecule thereof, a reactive polydimethylsiloxane having at least one reactive group selected from the group consisting of an amino group, an epoxy group, a carboxy group, a hydroxy group, a halogen atom, a thiol group, and a (meth)acrylate group in a side chain or terminal group thereof, and an aliphatic or aromatic polyisocyanate compound;
10-80 parts by weight of a (meth)acrylate-based monomer having a functionality of 4 or less, based on 100 parts by weight of the urethane-polydimethylsiloxane copolymerization prepolymer; and
0.1-10 parts by weight of a photoinitiator, based on 100 parts by weight of the urethane-polydimethylsiloxane copolymerization prepolymer.

2. The photo-curable composition of claim 1, further comprising 0.1-10 parts by weight of a mono-functional aliphatic thiol compound having a carbon number of 1 to 30, a mono-functional aliphatic alcohol compound having a carbon number of 1 to 30, or a mixture thereof, based on 100 parts by weight of the urethane-polydimethylsiloxane copolymerization prepolymer.

3. The photo-curable composition of claim 1, wherein the polyol, the reactive polydimethylsiloxane, and the aliphatic or aromatic polyisocyanate compound are in a mass ratio of 30˜70% by weight: 15˜65% by weight: 5˜20% by weight.

4. The photo-curable composition of claim 1, wherein the polyol is polyether-based polyol, polyester-based polyol, or a mixture thereof.

5. The photo-curable composition of claim 1, wherein the reactive polydimethylsiloxane is at least one compound represented by the formula 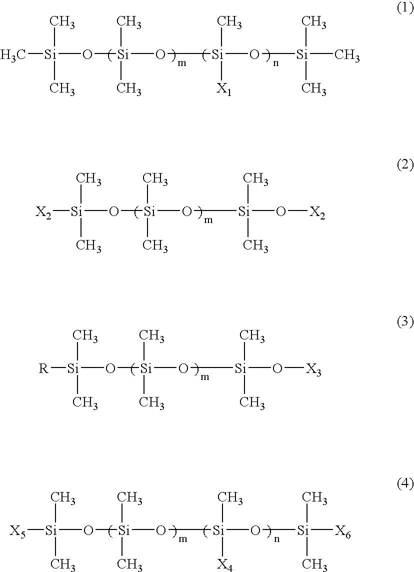
wherein m and n may be the same or different, each independently representing an integer from 1 to 20;
X₁-X₆ may be the same or different, each independently representing at least one reactive group represented by the formula 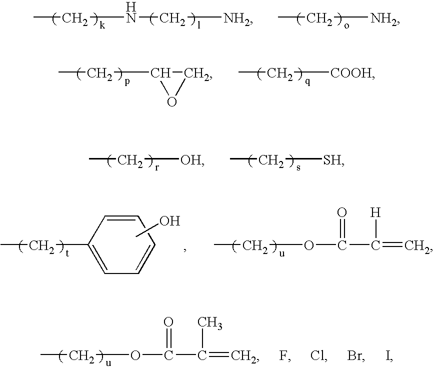
wherein k, l, o, p, q, r, s, t, and u are independently an integer from 0 to 10, which may be the same or different, and
R is an alkyl or alkoxy group having a carbon number of 1 to 10.

6. The photo-curable composition of claim 1, wherein the reactive polydimethylsiloxane is at least one compound represented by the following formulas (5) through (7): 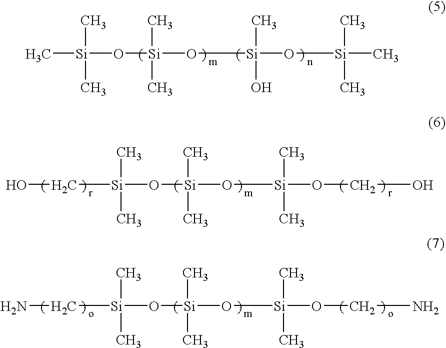
where m, n, o, and r are independently an integer from 0 to 10, which may be the same or different.

7. The photo-curable composition of claim 1, wherein the photoinitiator is a free radical initiator, a cationic initiator or a mixture thereof.

8. A method of forming a patterned polymer layer on a substrate, the method comprising:
forming a photo-curable composition coating on a substrate;
imprinting the photo-curable composition coating by embedding a stamper having a predetermined pattern in the photo-curable composition;
irradiating the photo-curable composition coating with light to cure the composition, while the stamper is embedded in the photo-curable composition coating; and
separating the stamper from the photo-curable composition coating on the substrate, wherein the photo-curable composition comprises:
100 parts by weight of a urethane-polydimethylsiloxane copolymerization prepolymer formed by a reaction of a polyol having two or more hydroxyl groups in a molecule thereof, a reactive polydimethylsiloxane having at least one reactive group selected from the group consisting of an amino group, an epoxy group, a carboxy group, a hydroxy group, a halogen atom, a thiol group, and a (meth)acrylate group in a side chain or terminal group thereof, and an aliphatic or aromatic polyisocyanate compound;
10-80 parts by weight of (meth)acrylate-based monomer having a functionality of 4 or less, based on 100 parts by weight of the urethane-polydimethylsiloxane copolymerization prepolymer; and
0.1-10 parts by weight of a photoinitiator, based on 100 parts by weight of the urethane-polydimethylsiloxane copolymerization prepolymer.

9. The method of claim 8, wherein the photo-curable composition further comprises 0.1-10 parts by weight of a mono-functional aliphatic thiol compound having a carbon number of 1 to 30, a mono-functional aliphatic alcohol compound having a carbon number of 1 to 30, or a mixture thereof, based on 100 parts by weight of the urethane-polydimethylsiloxane copolymerization prepolymer.

10. The method of claim 8, wherein the polyol, the reactive polydimethylsiloxane, and the aliphatic or aromatic polyisocyanate compound are in a mass ratio of 30˜70% by weight: 15˜65% by weight: 5˜20% by weight.

11. The method of claim 8, wherein the polyol is polyether-based polyol, polyester-based polyol, or a mixture thereof.

12. The method of claim 8, wherein the reactive polydimethylsiloxane is at least one compound represented by the following formulas: 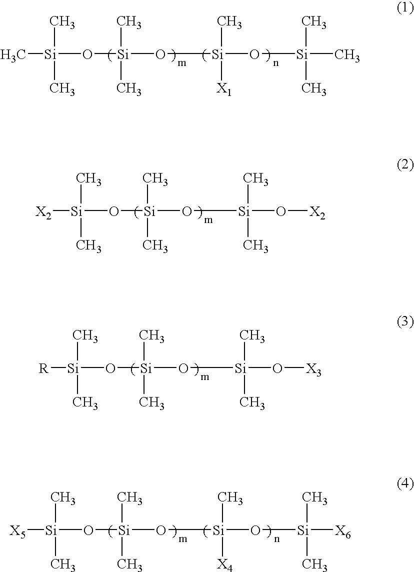
wherein m and n may be the same or different, each independently representing an integer from 1 to 20;
X₁-X₆ may be the same or different, each independently representing at least one reactive group represented by the following formulas: 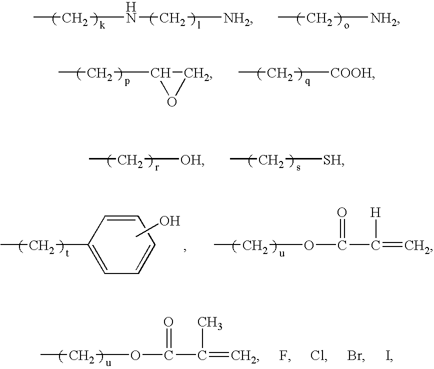
wherein k, l, o, p, q, r, s, t, and u are each independently an integer from 0 to 10, which may be the same or different, and R is an alkyl or alkoxy group having a carbon number of 1 to 10.

13. The method of claim 8, wherein the reactive polydimethylsiloxane is at least one compound represented by the following formulas (5) through (7): 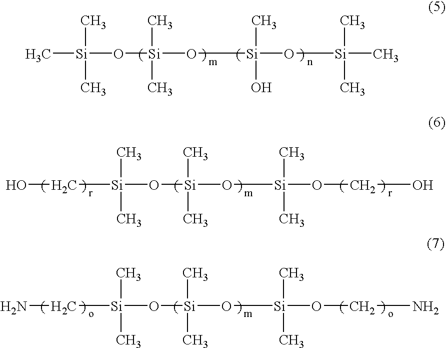
where m, n, o, and r are independently an integer from 0 to 10, which may be the same or different.

14. The method of claim 8, wherein the photoinitiator is a free radical initiator, a cationic initiator or a mixture thereof.

15. The method of claim 8, wherein the predetermined pattern of the stamper comprises a plurality of concave projections each having a height ranging from about 20 nm to about 100 nm.

16. The method of claim 8, wherein the patterned polymer pattern layer formed on the substrate is a recording mark of an optical recording medium.

17. The method of claim 8, wherein the substrate is a polyolefin film, a polyester film, a polycarbonate film, an acryl resin film, an epoxy resin film, or a glass substrate.

18. An optical recording medium comprising:
a substrate; and
a recording layer formed on the substrate, wherein the recording layer comprises a polymer pattern layer including a recording mark having a predetermined pattern, the polymer pattern layer being formed by curing the photo-curable composition claim 1.

19. The optical recording medium of claim 18, wherein the recording mark comprising a plurality of pits each having a height ranging from about 20 nm to about 100 nm.

20. The optical recording medium of claim 18, wherein the recording layer comprises a plurality of stacked polymer pattern layers, each polymer pattern layer including a recording mark having a predetermined pattern having a plurality of pits each having a height ranging from about 20 nm to about 100 nm, and polymer pattern layer comprising a cured photo-curable composition of claim 1.

21. The optical recording medium of claim 20, wherein a dielectric layer is formed between each of the plurality of polymer pattern layers.
